(19) United States
(12) Patent Application Publication
(10) Pub. No.: US 2011/0169347 A1
(43) Pub. Date: Jul. 14, 2011

(54) LINEAR MOTOR AND PORTABLE DEVICE PROVIDED WITH LINEAR MOTOR

(76) Inventors: Hideaki Miyamoto, Gifu (JP); Yoshinori Shishida, Gifu (JP); Kazunari Honma, Gifu (JP)

(21) Appl. No.: 13/062,392

(22) PCT Filed: Aug. 24, 2009
(86) PCT No.: PCT/JP2009/064690

§ 371 Date: Mar. 4, 2011

(30) Foreign Application Priority Data
Sep. 5, 2008 (JP) 2008-228562
Oct. 28, 2008 (JP) 2008-277448

(51) Int. Cl. H02K 41/035

(52) U.S. Cl. 310/12.21

(57) ABSTRACT

A linear motor whose thickness can be reduced is obtained. This linear motor (100) includes a spiral coil (141), wherein the spiral coil has a first section (141a, 141b) and a second section (141c, 141d) and is so formed that the magnitude of a magnetic flux of a magnetic field generated by current flowing in the first section is larger than the magnitude of a magnetic flux of a magnetic field generated by current flowing in the second section.

### TECHNICAL FIELD

The present invention relates to a linear motor and a portable device provided with a linear motor.

### BACKGROUND ART

A vibrating motor including a movable portion vibrating through electromagnetic force from a coil is known in general.

A vibrating actuator (vibrating motor) including a needle formed by a discoidal magnet and a coil arranged to surround the needle is disclosed in Japanese Patent Laying-Open No. 2006-68688. In the vibrating actuator described in Japanese Patent Laying-Open No. 2006-68688, the coil having a large thickness in the vertical direction is arranged to surround a discoidal movable portion, and formed to linearly move the discoidal movable portion in the vertical direction (thickness direction of the movable portion) through electromagnetic force from the coil.

A vibrator including a permanent magnet, an oscillator arranged to be opposed to the permanent magnet and a movable coil coupled to the oscillator and cylindrically formed is disclosed in Japanese Patent Laying-Open No. 2004-174309. In the vibrator described in Japanese Patent Laying-Open No. 2004-174309, the winding surface of the coil is arranged in a direction orthogonal to a bar-shaped guide rail extending in the direction of movement of the oscillator, and the movable coil is formed to vibrate with the oscillator in a direction along the guide rail.

### Prior Art

### Patent Document

Patent Document 1: Japanese Patent Laying-Open No. 2006-68688
Patent Document 2: Japanese Patent Laying-Open No. 2004-174309

### SUMMARY OF THE INVENTION

### Problems to be Solved by the Invention

The vibrating actuator disclosed in Japanese Patent Laying-Open No. 2006-68688 is so formed that the discoidal movable portion moves in the vertical direction (thickness direction of the movable portion) by employing the coil having the large thickness in the vertical direction, and hence there is such a problem that it is difficult to reduce the thickness of the apparatus.

In the vibrator disclosed in Japanese Patent Laying-Open No. 2004-174309, it follows that the winding surface of the cylindrical movable coil is arranged in the direction orthogonal to the direction of movement of the movable coil (direction along the guide rail). Therefore, the length of the movable coil in the height direction of the winding surface increases, and hence there is such a problem that it is difficult to reduce the thickness of the apparatus.

The present invention has been proposed in order to solve the aforementioned problems, and an object of the present invention is to provide a linear motor whose thickness can be reduced.

### Means for Solving he Problems

In order to attain the aforementioned object, a linear motor according to a first aspect of the present invention includes a spiral coil and a movable portion, having a pole face opposed to the spiral coil, provided to be movable along a direction along the surface of the spiral coil, while the spiral coil has a first section extending along a direction intersecting with the direction along which the movable portion moves and a second section extending along the direction along which the movable portion moves in plan view, and is so formed that the magnitude of a magnetic flux of a magnetic field generated by current flowing in the first section is larger than the magnitude of a magnetic flux of a magnetic field generated by current flowing in the second section.

A portable device according to a second aspect of the present invention is provided with a linear motor including a spiral coil and a movable portion, having pole face opposed to the spiral coil, provided to be movable along a direction along the surface of the spiral coil, in which the spiral coil has a first section extending along a direction intersecting with the direction along which the movable portion moves and a second section extending along the direction along which the movable portion moves in plan view, and is so formed that the magnitude of a magnetic flux of a magnetic field generated by current flowing in the first section is larger than the magnitude of a magnetic flux of a magnetic field generated by current flowing in the second section.

### Effects of the Invention

In the linear motor according to the first aspect of the present invention, the thickness can be reduced due to the aforementioned structure.

In the potable device according to the second aspect of the present invention, the thickness can be reduced due to the aforementioned structure.

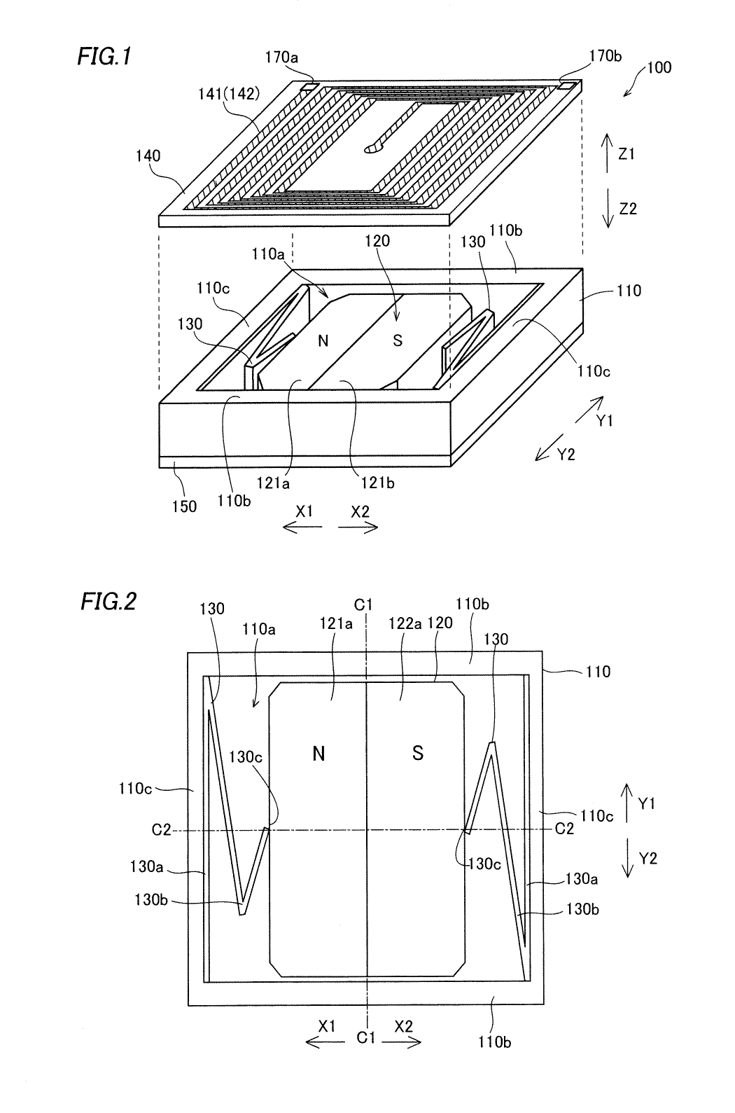

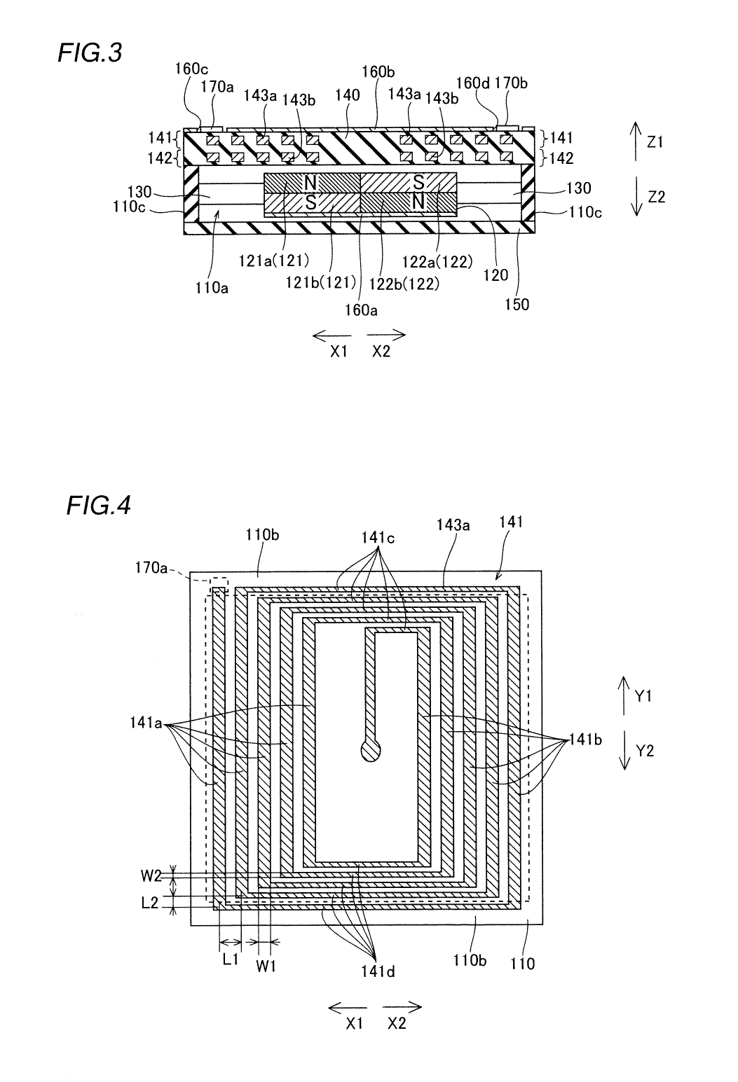

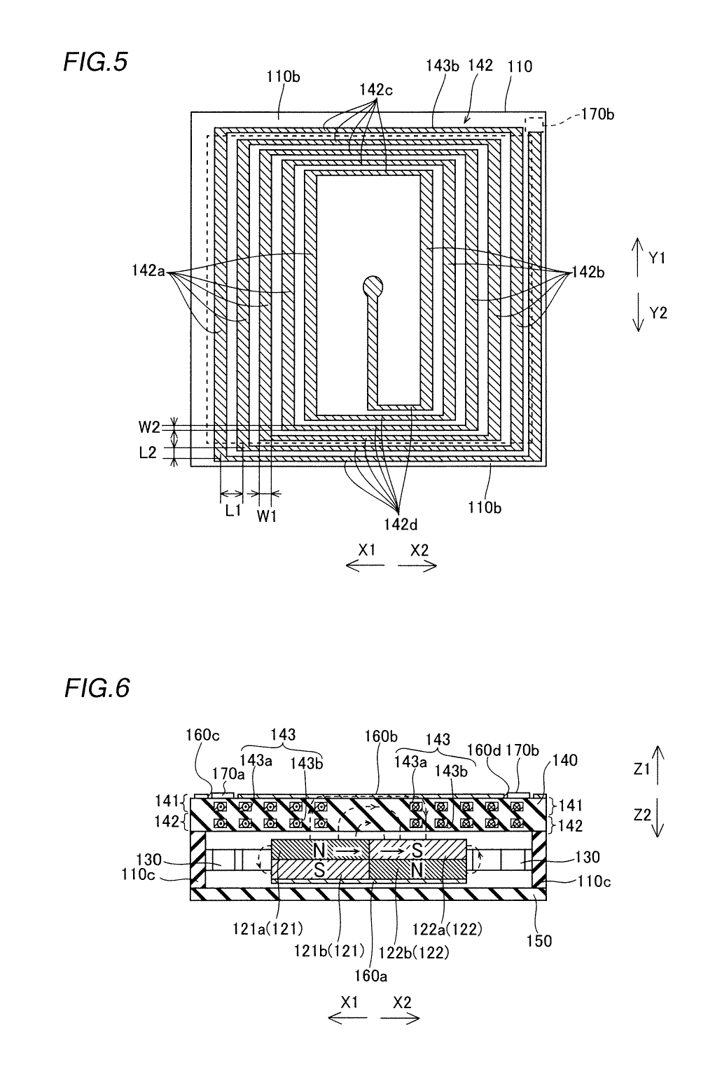

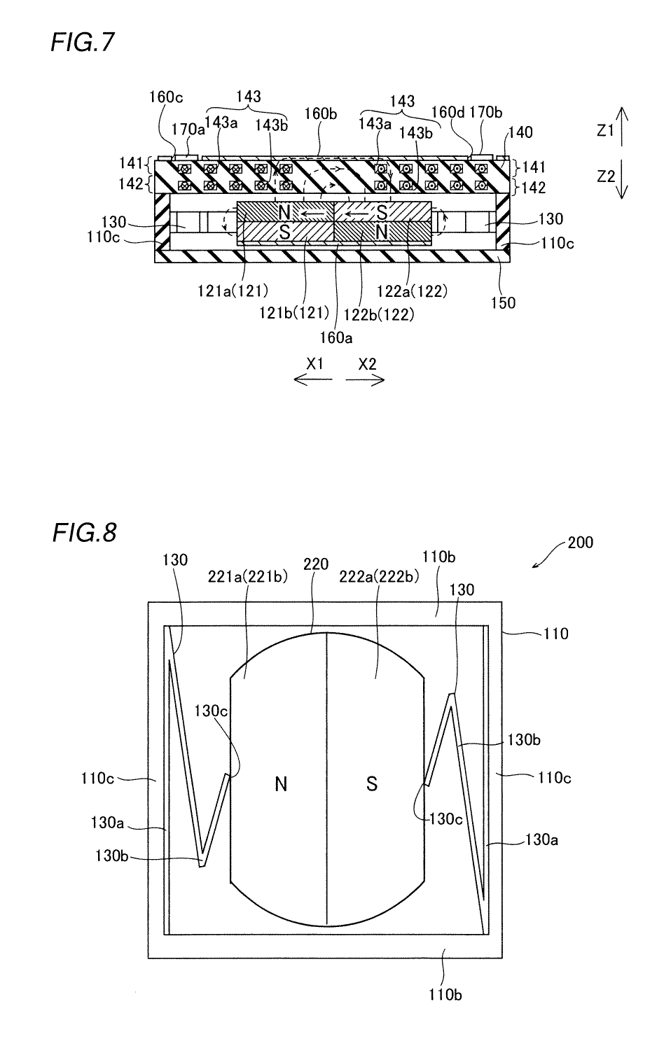

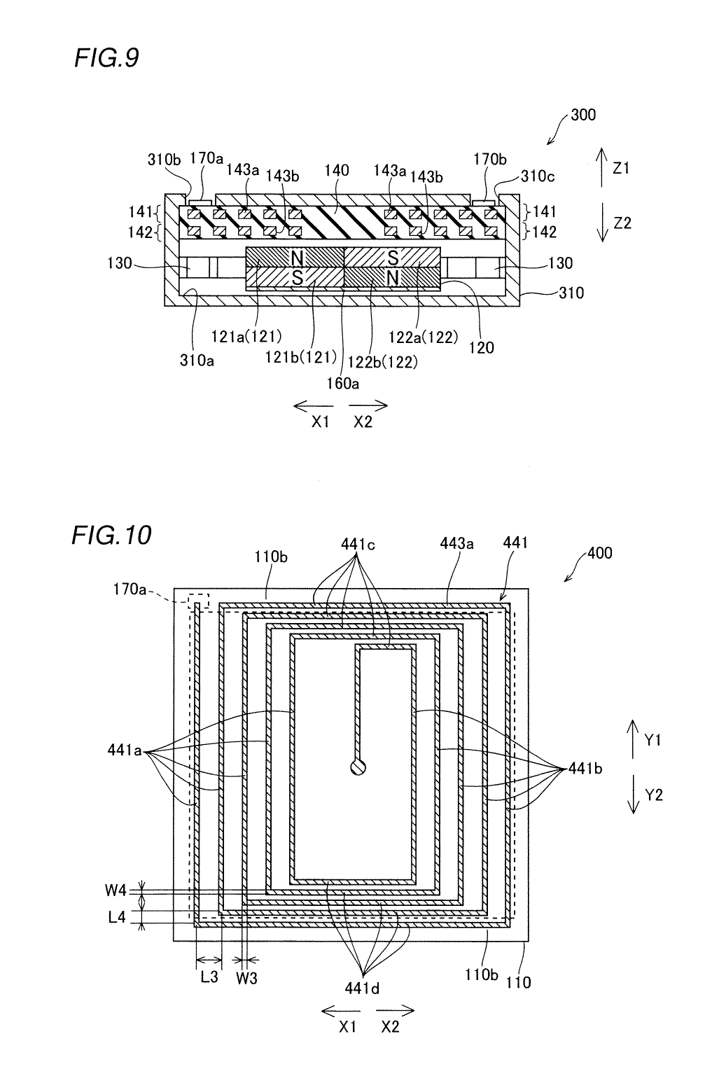

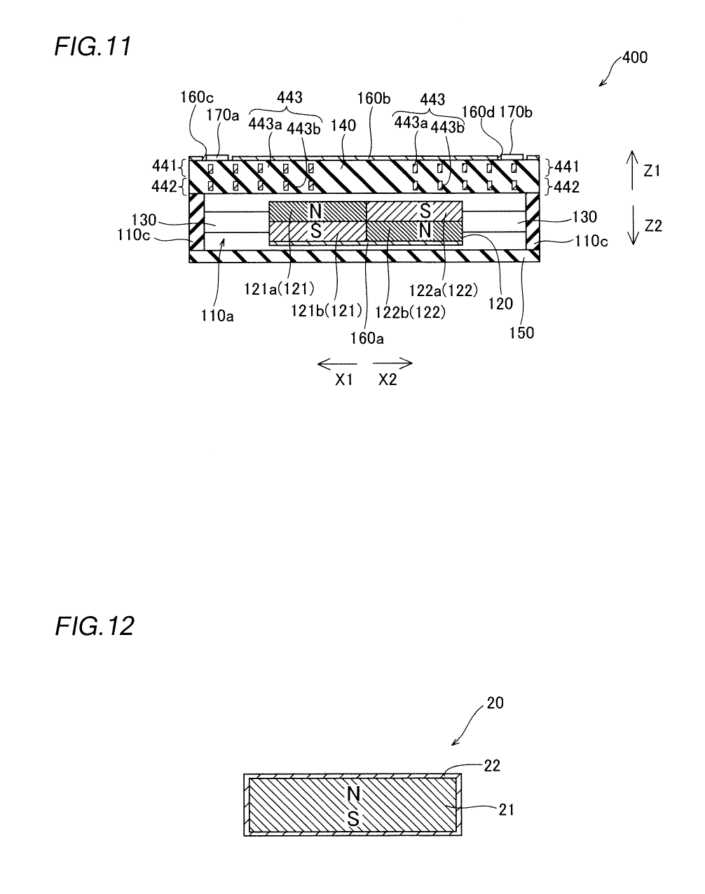

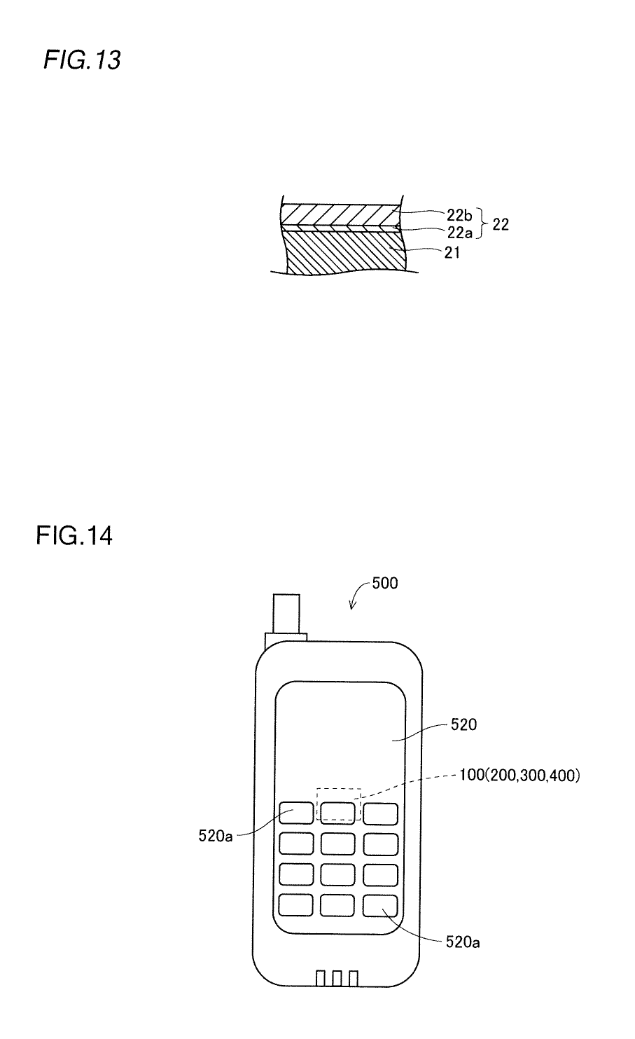

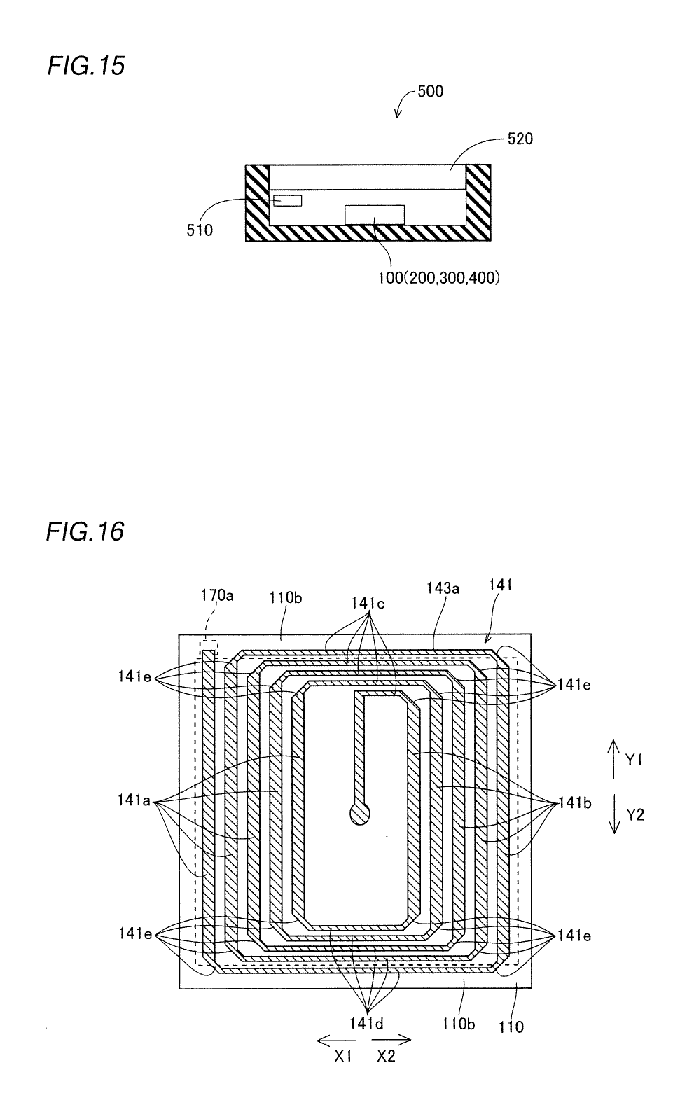

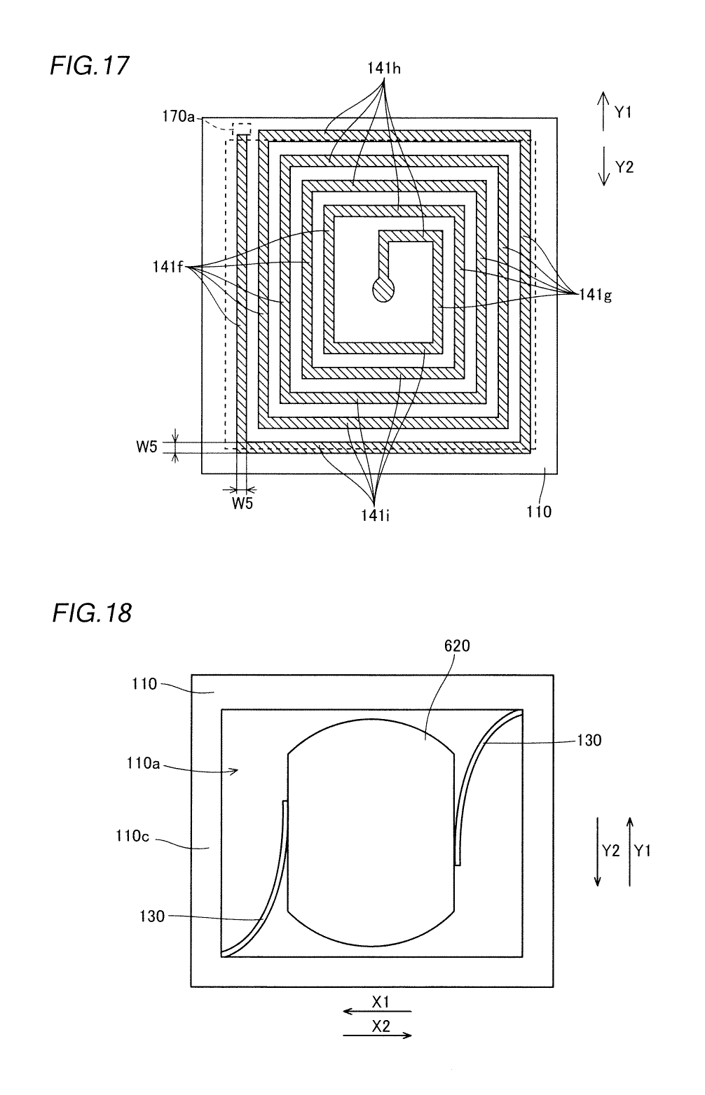

### BRIEF DESCRIPTION OF THE DRAWINGS

[FIG. 1] A perspective view showing the structure of a linear motor according to a first embodiment of the present invention.

[FIG. 2] A plan view of the linear motor according to the first embodiment.

[FIG. 3] A sectional view of the linear motor according to the first embodiment.

[FIG. 4] A plan view showing a first layer of planar coil of the linear motor according to the first embodiment.

[FIG. 5] A plan view showing a second layer of the planar coil of the linear motor according to the first embodiment.

[FIG. 6] A sectional view for illustrating operation of the linear motor according to the first embodiment.

[FIG. 7] A sectional view for illustrating the operation of the linear motor according to the first embodiment.

[FIG. 8] A plan view of a linear motor according to a second embodiment of the present invention.

[FIG. 9] A sectional view of a linear motor according to a third embodiment of the present invention.

[FIG. 10] A plan view of a linear motor according a fourth embodiment of the present invention.

[FIG. 11] A sectional view of the linear motor according to the fourth embodiment of the present invention.

[FIG. 12] A sectional view of a movable portion constituting a linear motor according to a fifth embodiment of the present invention.

[FIG. 13] An enlarged sectional view of the movable portion constituting the linear motor according to the fifth embodiment of the present invention.

[FIG. 14] A plan view showing the structure of a portable device according to a sixth embodiment of the present invention.

[FIG. 15] A sectional view showing the structure of the portable device according to the sixth embodiment of the present invention.

[FIG. 16] A plan view for illustrating a modification of the first to fourth embodiments of the present invention.

[FIG. 17] A plan view for illustrating another modification of the first to fourth embodiments of the present invention.

[FIG. 18] A plan view for illustrating a modification of the fifth embodiment of the present invention.

### MODES FOR CARRYING OUT THE INVENTION

Embodiments of the present invention are now described with reference to the drawings.

### First Embodiment

A linear motor (linear-driven vibrating motor) 100 according to a first embodiment includes a frame body 110 provided with a storing portion 110a, a movable portion 120 arranged in the storing portion 110a and a pair of plate springs 130 supporting the movable portion 120, as shown in FIGS. 1 and 2.

The frame body 110 is substantially rectangularly (squarely) formed by first sidewall portions 110b extending in directions of arrows X1 and X2 and second sidewall portions 110c extending in directions of arrows Y1 and Y2 in plan view, while the storing portion 110a of the frame body 110 is formed by a rectangular opening passing through the frame body 110 in the vertical direction (in directions of arrows Z1 and Z2). In the frame body 110, a printed board 140 is arranged to block the opening of the storing portion 110a on the upper direction side (side of the direction of arrow Z1), while a bottom plate 150 is arranged to block the opening on the lower direction side (side of the direction of arrow Z2). The frame body 110, the printed board 140 and the bottom plate 160 are made of glass epoxy resin. The frame body 110, the printed board 140 and the bottom plate 160 are examples of the “housing” in the present invention.

The movable portion 120 is in the form of a rectangle (oblong) whose corner portions are chamfered in plan view as shown in FIG. 2, and formed by a planar permanent magnet (magnet made of a ferromagnetic material such as ferrite or neodymium). The movable portion 120 has length of about 8 mm along the directions of arrows X1 and X2, and has a length of about 10 mm along directions of arrows Y1 and Y2. The side surfaces of the movable portion 120 are supported by a pair of plate springs 130, so that the movable portion 120 is positioned substantially at the center of the storing portion 110a of the frame body 110 in plan view. As shown in FIG. 3, the movable portion 120 has a height (small thickness) lower than the height of the storing portion 110a.

The movable portion 120 is constituted of two permanent magnets consisting of a first magnet 121 and a second magnet 122, as shown in FIG. 3. More specifically, the movable portion 120 is so formed that the first magnet 121 is arranged on the side of the direction of arrow X1 and the second magnet 122 is arranged on the side of the direction of arrow X2 through a portion around a centerline C1-C1 (see FIG. 2) of the movable portion 120. A north pole face 121a magnetized to the north pole in the thickness direction is provided on a side of the first magnet 121 opposed to the printed board 140. Further, a south pole face 122a magnetized to the south pole in the thickness direction is provided on a side of the second magnet 122 opposed to the printed board 140. The north pole and the south pole are examples of the “first polarity” and the “second polarity” in the present invention respectively, while the north pole face 121a and the south pole face 122a are examples of the “first pole face” and the “second pole face” in the present invention respectively.

A south pole face 121b magnetized to the south pole in the thickness direction is provided on a side of the first magnet 121 opposed to the bottom plate 150. Similarly, a north pole face 122b magnetized to the north pole in the thickness direction is provided on a side of the second magnet 122 opposed to the bottom plate 150.

The first magnet 121 and the second magnet 122 are so arranged that the north pole face 121a and the south pole face 122a are adjacent to each other on the surfaces closer to the printed board 140 and the south pole face 121b and the north pole face 122b are adjacent to each other on the surfaces closer to the bottom plate 150. The first magnet 121 and the second magnet 122 are held in a state adhering to each other due to the attraction between the north pole face 121a and the south pole face 122a adjacent to each other and the attraction between the south pole face 121b and the north pole face 122b, and fixed to each other with an adhesive or the like.

Thus, the movable portion 120 linearly moves in the directions of arrows X1 and X2 parallel to the printed board 140 in the storing portion 110a, in the state supported by the pair of plate springs 130. Here, parallel includes not only a state parallel to each other but also a state deviating from the parallel state (state inclined by a prescribed angle) to an extent not hindering the linear movement of the movable portion 120. At this time, the first sidewall portions 110b (see FIG. 2) function as guides for the movable portion 120 moving in the directions of arrows X1 and X2.

The pair of plate springs 130 are arranged on inner side surfaces of the second sidewall portions 110c of the frame body 110 respectively, as shown in FIGS. 1 and 2. More specifically, the pair of plate springs 130 are constituted of fixed portions 130a fixed to the frame body 110, deformable portions 130b and support portions 130c for the movable portion 120 respectively. The fixed portions 130a are formed to extend along the directions of arrows Y1 and Y2, and fixed to the second sidewall portions 110c of the frame body 110 with an adhesive or the like. The deformable portions 130b are bent a plurality of times (twice) from boundary portions between the same and the fixed portions 130a up to the support portions 130c to be deformable so that the loci of the support portions 130c of the pair of plate springs 130 linearly move on a centerline C2-C2 along the directions of arrows X1 and X2, and have functions of mutually urging the movable portion 120 toward the plate springs 130 on the other sides. The support portions 130c of the respective plate springs 130 are formed to support the movable portion 120 to surround the same in the vicinity of a portion of the storing portion 110a of the frame body 110 on the centerline C2-C2 respectively.

A yoke 160a formed by an iron plate or the like is provided on the surfaces of the sides of the first magnet 121 and the second magnet 122 opposed the bottom plate 150. The yoke 160a is an example of the “movable portion-side yoke” in the present invention. Another yoke 160b formed by an iron plate or the like is similarly provided also on the surface of the printed board 140 opposite to the side opposed to the movable portion 120. The yoke 160b is an example of the “coil-side yoke” in the present invention. The yokes 160a and 160b have functions as magnetic shields for inhibiting magnetism from leaking out of the apparatus body.

Flat-shaped (planar-shaped) planar coils 141 and 142 consisting of two-layer wiring structures are arranged in the printed board 140, as shown in FIGS. 3 to 5. The planar coils 141 and 142 have rectangular contours in plan view respectively, and are spirally formed to spread from the inner sides toward the outer sides in the direction of an X-Y plane (plane formed by the direction of arrow X1 (X2) and the direction of arrow Y1 (Y2)). The planar coils 141 and 142 are examples of the “coil” in the present invention respectively.

The planar coils 141 and 142 are electrically connected in series with each other by one current line 143. More specifically, a first-layer current line 143a constituting the planar coil 141 is spirally wound anticlockwise from the outer side toward the inner side, as shown in FIG. 4. An outer end portion of the first-layer current line 143a of the planar coil 141 is connected to an electrode pad 170a provided on the printed board 140.

A second-layer current line 143b constituting the planar coil 142 is spirally wound anticlockwise cm the inner side toward the outer side, as shown in FIG. 5. An outer end portion of the second-layer current line 143b of the planar coil 142 is connected to another electrode pad 170b provided on the printed board 140. An inner end portion of the first-layer current line 143a constituting the planar coil 141 and an inner end portion of the second-layer current line 143b constituting the planar coil 142 are connected with each other through a contact hole provided in the printed board 140 in the vicinity of the respective central portions. The yoke 160b is provided with openings 160c and 160d on positions corresponding to the electrode pads 170a and 170b on the printed board 140 respectively, so that the yoke 160b and the electrode pads 170a and 170b are not in contact with each other.

As shown in FIG. 4, the planar coil 141 has first sections 141a and 141b extending in the directions of arrows Y1 and Y2 and second sections 141c and 141d extending in the directions of arrows X1 and X2 respectively. In other words, the first sections 141a and 141b are provided on the respective sides in the direction of arrow X1 and the direction of arrow X2 along which the movable portion 120 moves in the printed board 140. The current line 143a is so formed that the width V2 of portions of the current line 143a constituting the second sections 141c and 141d is smaller than the width W1 of portions of the current line 143a constituting the first sections 141a and 141b of the planar coil 141a and 141b of the planar coil 141. Thus, the pitch (distance between the centers of adjacent portions of the current line 143a) L2 of the portions of the current line 143a constituting the second sections 141c and 141d is smaller than the pitch L1 of the portions of the current line 143a constituting the first sections 141a and 141b. Consequently, the magnitude of a magnetic flux of a magnetic field generated by current flowing in the first sections 141a and 141b is larger than the magnitude of a magnetic flux of a magnetic field generated by current flowing in the second sections 141c and 141d.

At least parts of the second sections 141c and 141d are arranged to overlap the first sidewall portions 110b of the frame body 110 respectively in plan view. In other words, the arrangement region of the planar coil 141 is larger than the movable portion 120 in plan view, and covers the entire movable portion 120.

As shown in FIG. 5, the planar coil 142 is similar in structure to the planar coil 141, and has first sections 142a and 142b extending in the directions of arrows Y1 and Y2 and having the width 41 and second sections 142c and 142d extending in the directions of arrows X1 and X2 and having the width W2. Parts of the second sections 142c and 142d are arranged to overlap the first sidewall portions 110b of the frame body 110 respectively. The first sidewall portions 110b are examples of the “sidewall portion” in the present invention.

In a stationary state, the first sections 141a (142a) of the planar coil 141 (142) are superposed on the north pole face 121a of the movable portion 120 and the first sections 141b (142b) are superposed on the south pole face 122a in plan view.

Thus, when driving current is supplied to the planar coils 141 and 142, the directions of the current are opposite to each other in the first sections 141a (142a) and the first sections 141b (142b). The upper-layer planar coil 141 and the lower-layer planar coil 142 are so connected with each other that the current flows in the same direction in portions of the upper-layer planar coil 141 and portions of the lower-layer planar coil 142 corresponding to the portions of the upper-layer planar coil 141. Electromagnetic force by the first sections 141a (142a) and the first sections 141b (142b) become driving force for moving the movable portion 120.

Operation of the linear motor 100 according to the first embodiment of the present invention is now described with reference to FIGS. 4 to 7.

First, driving current is supplied to the current line 143 through the electrode pads 170a and 170b. Thus, as shown in FIG. 6, the current flows in the first sections 141a (142a) of the planar coil 141 (142) from the rear side toward the front side of the plane of the figure. Further, the current flows in the first sections 141b (142b) of the planar coil 141 (142) from the front side toward the rear side of the plane of the figure.

The direction of a magnetic field generated between the north pole face 121a and the south pole face 122a of the movable portion 120 is the direction from the surface of the north pole face 121a toward the printed board 140, i.e., the direction Z1 on the north pole face 121a, as shown by broken arrow in FIG. 6. On the south pole face 122a, on the other hand, it is the direction from the printed board 140 toward the south pole face 122a, i.e., the direction Z2. Thus, it follows that the direction of the magnetic field generated between the north pole face 121a and the south pole face 122a of the movable portion 120 is orthogonal to the directions of the current flowing in the first sections 141a (142a) and the first sections 141b (142b) of the planar coil 141 (142). Therefore, the current flowing in the first sections 141a (142a) of the planar coil 141 (142) receives force from the magnetic field of the north pole face 121a of the first magnet 121 in the direction of arrow X1. At the same time, the current flowing in the first sections 141b (142b) of the planar coil 141 (142) receives force from the magnetic field of the south pole face 122a of the second magnet 122 in the direction of arrow X1. However, the first sections 141a (142a) of the planar coil 141 (142) and the first sections 141b (142b) of the planar coil 141 (142) are fixed to the printed board 140, and hence the movable portion 120 is linearly moved in the direction of arrow X2 due to reaction.

After a prescribed time, driving current in a direction opposite o the state shown in FIG. 6 is supplied as shown in FIG. 7, whereby the movable portion 120 is linearly moved in the direction of arrow X1 through action similar to the above. Thus, the direction of the driving current is switched at a prescribed frequency, whereby the movable portion 120 is alternately linearly moved in the direction of arrow X1 and the direction of arrow X2 to be resonance-moved. At this time, a magnetic flux generated between the south pole face 121b of the first magnet 121 and the north pole face 122b of the second magnet 122 is absorbed by the yoke 160a to selectively pass in the yoke 160a, whereby the same is not so generated as to reach the outer side through the bottom plate 150. On the other hand, a magnetic flux generated between the north pole face 121a of the first magnet 121 and the south pole face 122a of the second magnet 122 is absorbed by the yoke 160b to selectively pass in the yoke 160b in a case of passing through the printed board 140, whereby the same is not so generated as to reach the outer side of the yoke 160b.

At this time, force in directions toward the center along the directions of arrows Y1 and Y2 or force in outwardly pulling directions from the center along the directions of arrows Y1 and Y2 is applied to the movable portion 120 through electromagnetic force generated by the second sections 141c (142c) and 141d (142d) opposed to each other in the planar coil 141 (142).

In the linear motor 100 according to the first embodiment of the present invention, the following effects can be attained:

(1) The linear motor 100 of transverse vibration (vibration in the directions of arrows X1 and X2) is so formed that the thickness thereof can be easily reduced as compared with a linear motor of longitudinal vibration (vibration in the directions of arrows Z1 and Z2).

(2) The movable portion 120 movable along the directions (directions of arrows X1 and X2) along the surfaces of the planar coils 141 and 142 has been provided. Thus, no moving range (moving space toward the vertical direction) for the movable portion 120 may be provided as compared with a case of linearly moving the movable portion 120 in the vertical direction with coils having large thicknesses in the vertical direction (directions Z), whereby the degree of freedom in design for reducing the thickness in the direction can be ensured. Consequently, the linear motor 100 whose thickness can be reduced can be provided.

(3) The planar coils 141 and 142 have been spirally formed to be flat along the directions of movement of the movable portion 120. Thus, no regions toward the height direction (height direction) by winding surfaces of the coils may be provided as compared with a case where the winding surfaces of the coils are arranged in a direction orthogonal to the directions of movement of the movable portion, and the thicknesses in the directions of arrows Z1 and Z2 can be reduced. Therefore, the thickness of the linear motor 100 can be reduced.

(4) The linear motor 100 includes the movable portion 120 including the north pole face 121a and the south pole face 122a different in polarity from each other on the surface opposed to the planar coil 141 (142), and the first sections 141a and 141b (142a and 142b) of the planar coil 141 (142), in which the directions along which the current flows are opposite to each other, have been arranged on positions corresponding to the north pole face 121a and the south pole face 122a respectively. Thus, force applied to the north pole face 121a and the south pole face 122a through electromagnetic force generated when the current flows in the planar coil 141 (142) is in the same direction, whereby the movable portion 120 can be moved in the direction. In other words, the linear motor can be constituted of one spiral planar coil, whereby the apparatus can be downsized (reduced in area).

In a case where the polarity of the permanent magnets on the side opposed to the coil consists of only one type, coils must be arranged on both sides respectively in order to move the movable portion in one direction and another direction, and hence downsizing (area reduction) of the apparatus has a constant limit.

(5) The movable portion 120 has been so formed that the north pole face 121a and the south pole face 122a thereof are arranged to be opposed to the surface of the planar coil 141 (142). Thus, a line of magnetic force (pole face on which the line of magnetic force is formed) generated from the side of the movable portion 120 and a line of magnetic induction (coil surface on which the line of magnetic induction is formed) generated by feeding current to the planar coil 141 (142) are parallelized. In the structure described in the aforementioned Japanese Patent Laying-Open No. 2004-174309, on the other hand, a line of magnetic force from the magnet and a line of magnetic induction from the coil are orthogonal to each other. Therefore, the overlapping quantity of the line of magnetic force and the line of magnetic induction is large in the structure in the linear motor 100 as compared with the structure described in the aforementioned Japanese Patent Laying-Open No. 2004-174309, whereby the driving force at the time of moving the movable portion 120 can be increased.

(6) On the surface of the movable portion 120 opposite to the surface opposed to the planar coil 142 (142), the south pole face 121b has been provided on the position corresponding to the north pole face 121a, while the north pole face 122b has been provided on the position corresponding to the south pole face 122a. Thus, the north pole face 121e, the south pole face 122e, the south pole face 121b and the north pole face 122b of the movable portion 120 are so arranged that different magnetic poles are adjacent to each other in the directions (directions of arrows X1 and X2) of movement of the movable portion 120 and in the thickness direction (directions of arrows Z1 and Z2). Therefore, the lengths of the magnetic fluxes generated between the respective pole faces are reduced, whereby the magnetic fluxes can be inhibited from leaking out of the linear motor 100. Consequently, in a case of arranging the linear motor 100 in various apparatuses, the apparatuses can be inhibited from causing defective operation resulting from magnetic flux leakage from the linear motor 100.

(7) The yoke 160a functioning as a magnetic shield is provided on the surfaces of the south pole face 121b and the north pole face 122b of the movable portion 120, whereby the magnetic flux generated between the south pole face 121b and the north pole face 122b can be reliably inhibited from leaking outward from the side of the bottom plate 150 of the linear motor 100. Further, the yoke 160b is arranged also on the surface of the printed board 140, whereby the magnetic flux is generated between the north pole face 121a and the south pole face 122a to pass in the yoke 160b while passing through the planar coils 141 and 142. Therefore, the magnetic flux generated between the north pole face 121a and the south pole face 122a can be reliably inhibited from leaking outward from the side of the printed board 140. Thus, outward magnetic flux leakage from the linear motor 100 can be easily suppressed.

(8) The pair of plate springs 130 supporting the movable portion 120 from both sides are provided in such shapes that the support portions 130c with the movable portion 120 are bent to be deformed along the directions (directions of arrows X1 and X2) of movement of the movable portion 120, whereby the loci of the support portions 130c linearly move along the directions of arrows X1 and X2 in the plate springs 130. Thus, the support portions 130c support the movable portion 120 while linearly moving along the directions of arrows X1 and X2, whereby contact portions between the support portions 130c and the movable portion 120 can be inhibited from causing deviation when the movable portion 120 moves. Consequently, the movable portion 120 can be inhibited from rotating while moving, whereby the linear motor 100 can be stably operated.

(9) The movable portion 120 is in the form of the rectangle whose corner portions are chamfered, whereby hitching between the movable portion 120 and the first sidewall portions 110b of the frame portion 110 can be suppressed when the movable portion 120 moves, as compared with a case where the corner portions are not chamfered. Therefore, the movable portion 120 can be more reliably inhibited from rotation resulting from such hitching.

(10) The planar coil 141 (142) has been provided with the first sections 141a and 141b (142a and 142b) extending in the directions (directions of arrows Y1 and Y2) intersecting with the directions along which the movable portion 120 moves and the second sections 141c and 141d (142c and 142d) extending in the directions (directions of arrows X1 and X2) along which the movable portion 120 moves. Further, the current line 143a (143b) has been so formed that the pitch L2 of the adjacent portions constituting the second sections 141c and 141d (142c and 142d) is smaller than the pitch L1 of the adjacent portions of the current line 143a (143b) constituting the first sections 141a and 141b (142a and 142b).

Thus, the pitch L2 of the second sections 141c and 141d (142c and 142d) is so reduced that the lengths of the first sections 141a and 141b (142a and 142b) in the directions of arrows Y1 and Y2 are increased, whereby the electromagnetic force for moving the movable portion 120 can be increased, and a response time of the movable portion 120 can be reduced.

(11) The current line 143a (143b) has been so formed that the pitch L2 of the adjacent portions of the current line 143a (143b) constituting the second sections 141c and 141d (142c and 142d) is smaller than the pitch L1 of the adjacent portions of the current line 143a (143c) constituting the first ions 141a and 141b (142a and 142b). Thus, resistance of the current line 143a (143b) can be reduced due to the large width W1 of the portions of the current line 143a (143b) constituting the first sections 141a and 141b (142a and 142b), whereby the quantity of the current flowing in the current line 143a (143b) can be increased. Consequently, the driving force for the movable portion 120 can be increased.

(12) Parts of the second sections 141c (142c) and 141d (142d) of the planar coil 141 (142) have been arranged to overlap the first sidewall portions 110b in plan view. Thus, a region where force in the directions of arrows Y1 and Y2 acts on the movable portion 120 can be reduced, whereby the movable portion 120 can be inhibited from deviating from a linear moving path due to the force in the directions of arrows Y1 and Y2 when linearly moving in the directions of arrows X1 and X2. Consequently, the linear motor 100 can be stably operated. Further, parts of the second sections 141c and 141d (142c and 142d) so overlap the first sidewall portions 110b of the frame body 110 that the lengths of the first sections 141a and 141b (142a and 142b) contributing to generation of the electromagnetic force for moving the movable portion 120 can be more increased, whereby the driving force for the movable portion 120 can be increased.

(13) The direction of the current flowing in the first sections 141a (142a) of the planar coil 141 (142) opposed to the north pole face 121a and the direction of the current flowing in the first sections 141b (142b) of the planar coil 141 (142) opposed to the south pole face 122a are substantially opposite directions. Thus, force in the same direction acts on the first sections 141a (142a) of the planar coil 141 (142) opposed to the north pole face 121a and the first sections 141b (142b) of the planar coil 141 (142) opposed to the south pole face 122a, whereby the movable portion 120 can be easily driven.

(14) The planar coil 141 (142) has been substantially rectangularly formed in plan view. Thus, the planar coil 141 (142) can be easily formed to have the first sections 141a and 141b (142a and 142b) extending along the direction intersecting with the directions along which the movable portion 120 moves and the second sections 141c and 141d (142c and 142d) extending along the directions along which the movable portion 120 moves in plan view.

(15) The first sections 141a and 141b (142a and 142b) of the planar coil 141 (142) have been provided on both of one direction side and another direction side of the directions along which the movable portion 120 moves in the printed board 140. Thus, the driving force at the time of moving the movable portion 120 can be increased as compared with a case of providing the first sections only on one side of the directions along which the movable portion 120 moves.

(16) The upper-layer planar coil 141 and the lower-layer planar coil 142 have been so connected with each other that the current flows in the same direction in the portions of the upper-layer planar coil 141 and the portions of the lower-layer planar coil 142 corresponding to the portions of the upper-layer planar coil 141. Thus, magnetic fluxes of the same direction can be generated in both coils of the upper-layer planar coil 141 and the lower-layer planar coil 142. Consequently, larger magnetic fluxes can be generated as compared with a case of providing only either the upper-layer planar coil 141 or the lower-layer planar coil 142.

### Second Embodiment

Referring to FIG. 8, an example of employing a movable portion 220 having a shape in which both ends of a circular shape are cut off is described in a second embodiment, dissimilarly to the first embodiment employing the rectangular movable portion 120 whose corner portions are chamfered.

The movable portion 220 is formed in the shape in which both ends of a circular shape are cut off in plan view. The movable portion 220 has a north pole face 221a magnetized to the north pole in the thickness direction and a south pole face 222a magnetized to the south pole in the thickness direction on a surface of a side opposed to planar coils 141 and 142, similarly to the first embodiment. On a surface opposite to the surface opposed to the planar coil 141 (142), the movable portion 220 is provided with a south pole face 221b magnetized to the south pole in the thickness direction in a region corresponding to the north pole face 2212a, and provided with a north pole face 222b magnetized to the north pole in the thickness direction in a region corresponding to the south pole face 222a.

The remaining structure and operation of the second embodiment are similar to those of the first embodiment.

In a linear motor 200 according to the second embodiment, the following effects can be attained, in addition to the aforementioned effects (1) to (16):

(17) The movable portion 220 has been brought into the shape in which both ends of a circular shape are cut off in plan view. Thus, the quantity of movement (moving range) of the movable portion 220 spreads by the range of the cut portions, whereby the range for accelerating the movable portion 220 can be spread. Therefore, the quantity of vibration of the linear motor 200 can be increased.

(18) In a case of moving the movable portion 220 in directions of arrows X1 and X2, the movable portion 220 in the second embodiment comes into line contact with first sidewall portions 110b as compared with the movable portion 120 in the first embodiment coming into surface contact with the first sidewall portions 110b functioning as guides, whereby frictional resistance can be reduced. Therefore, the movable portion 220 can be more stably operated.

### Third Embodiment

In a linear motor 300 in a third embodiment, an example of integrally forming portions corresponding to a frame portion, a bottom portion and a yoke is described, dissimilarly to the first embodiment separately forming the frame portion 110, the bottom plate 150 and the yoke 160b respectively.

In the linear motor 300, a movable portion 120 and a printed board 140 are arranged in a housing 310 formed in a rectangular tubular shape. The housing 310 is made of iron, for example, and functions as a magnetic shield for inhibiting magnetism generated from the movable portion 120 from leaking outward. In this case, a lid portion (not shown) or the like is mounted on an opening 310a after the printed board 140 is arranged in the housing 310 to be slid from the opening 310a thereof. In the housing 310, openings 310b and 310c are formed on positions corresponding to electrode pads 170a and 170b of the printed board 140.

The remaining structure and operation of the third embodiment are similar to those of the first embodiment.

In the linear motor 300 according to the third embodiment of the present invention, the following effect can be attained, in addition to the aforementioned effects (1) to (16):

(19) The housing 310 functioning as a magnetic shield is provided to cover the movable portion 120 formed by a permanent magnet, whereby a magnetic flux generated from the movable portion 120 can be easily inhibited from leaking outward. Further, the housing as the frame portion, the bottom plate and the yoke is so integrally provided that the number of components can be suppressed as compared with a case of separately providing the same respectively.

### Fourth Embodiment

In a fourth embodiment, an example of equalizing the magnitudes of the widths of first sections 441a (441b) and second sections 441c (441d) of a planar coil 441 to each other is described with reference to FIGS. 10 and 11, dissimilarly to the first embodiment forming the first sections 141a (141b) and the second sections 141c (141d) of the planar coil 141 with widths of different magnitudes.

In a linear motor 400, the planar coil 441 formed by a current line 443 has the first sections 441a and 441b extending in directions of arrows Y1 and Y2 and the second sections 441c and 441d extending in directions of arrows X1 and X2, as shown in FIG. 10. The width W3 of portions of a first-layer current line 443a constituting the first sections 441a and 441b of the planar coil 441 is substantially equal to the width W4 of portions of the current line 443a constituting the second sections 441c and 441d. The current line 443a is so formed that the pitch L4 (distance between the centers of adjacent portions of the current line 443a) of the portions of the current line 443a constituting the second sections 441c and 441d is smaller than the pitch L3 of the portions of the current line 443a constituting the first sections 441a and 441b.

Parts of the second sections 441c and 441d are arranged to overlap first sidewall portions 110b of a frame body 110 in plan view respectively. In other words, the arrangement region of the planar coil 441 is larger than a movable portion 120 in plan view, and arranged to cover the entire movable portion 120. The structure of a second-layer current line 443b (planar coil 442) shown in FIG. 11 is similar to that of the aforementioned first-layer current line 443a (planar coil 441). The remaining structure of the fourth embodiment is similar to that of the aforementioned first embodiment.

In the linear motor 400 according to the fourth embodiment of the present invention, the following effect can be attained, in addition to the aforementioned effects (1) to (9) and (12) to (16):

(20) The planar coil 441 has been provided with the first sections 441a and 441b extending in directions (directions of arrows Y1 and Y2) intersecting with directions along which the movable portion 120 moves and the second sections 441c and 441d extending in the directions (directions of arrows X1 and X2) in which the movable portion 120 moves. Further, the current line 443a has been so formed that the pitch L4 of the adjacent portions constituting the second sections 441c and 441d is smaller than the pitch L3 of the adjacent portions of the current line 443a constituting the first sections 441a and 441b.

Thus, the lengths of the first sections 441a and 441b in the directions of arrows Y1 and Y2 are increased due to the reduced pitch L4 of the second sections 441c and 441d, whereby electromagnetic force for moving the movable portion 120 can be increased, and a response time of the movable portion 120 can be reduced.

### Fifth Embodiment

In a fifth embodiment, an example of employing a movable portion 20 in which a fluororesin-containing nickel plating layer 22b is formed on the surface of a permanent magnet 21 is described, dissimilarly to the movable portions of the aforementioned first to fourth embodiments.

The movable portion 20 is constituted of the permanent magnet (magnet made of a ferromagnetic material such as ferrite or neodymium) 21 and the nickel plating layer 22 formed on the surface thereof, as shown in FIG. 12. Further, the nickel plating layer 22 is constituted of an electroless nickel plating layer 22a formed on the surface of the permanent magnet 21 and a fluororesin-containing nickel plating layer (fluorine-eutectoid nickel plating layer) 22b, made of particulate polytetrafluoroethylene formed on the surface thereof, as shown in FIG. 13. The electroless nickel plating layer 22a is a plating layer formed by employing a nickel plating solution through generally performed chemical reduction not employing an external power source, and functions as a bonding layer between the permanent magnet 21 and the fluororesin-containing nickel plating layer 22b. The fluororesin-containing nickel plating layer 22b is a plating layer formed by employing a plating solution prepared by dispersing polytetrafluoroethylene particles into a nickel plating solution in place of the aforementioned nickel plating solution, and has a function of reducing a coefficient of friction on the surface of the permanent magnet 21, along with prevention of oxidation of the permanent magnet 21. The electroless nickel plating layer 22a is an example of the “bonding metal plating layer” in the present invention. The fluororesin-containing nickel plating layer 22b is an example of the “fluororesin-containing metal plating layer” in the present invention. The remaining structure of the fifth embodiment is similar to those of the aforementioned first to fourth embodiments.

In the movable portion 20 according to the fifth embodiment of the present invention, the following effect can be attained:

(21) The particulate fluororesin-containing nickel plating layer 22b is provided on the surface of the movable portion 20, whereby frictional resistance of the movable portion 20 against a printed board 140 can be reduced due to lubricating action of fluororesin. Thus, at a time of movement of the movable portion 20, the quantity of current (driving current) supplied to planar coils 141 and 142 can be reduced by thrust corresponding to the quantity reduction of the frictional resistance. Consequently, a linear motor capable of reducing power consumption can be provided. Further, efficiency for converting electric energy to vibration is improved, whereby a response time (time required by the movable portion 20 to reach a prescribed quantity of vibration) of the movable portion 20 can be reduced.

### Sixth Embodiment

An example of a portable device employing the linear motor according to any of the first to fifth embodiments of the present invention is described.

The linear motor 100 (200 to 400) according to any of the first to fifth embodiments of the present invention can be employed for a portable telephone 500 or the like, as shown in FIGS. 14 and 15. The portable telephone 500 includes the linear motor 100 (200 to 400), a CPU 510 (see FIG. 15) and a display portion 520. The linear motor 100 (200 to 400) is arranged on a side of the portable telephone 500 opposite to a side where the display portion 520 is arranged. The display portion 520 is constituted of a panel of a touch panel system, and so formed that the user operates the portable telephone 500 by pressing button portions 520a displayed on the display portion 520. The linear motor 100 (200 to 400) is controlled by the CPU 510 to vibrate in a case of sensing that the button portions 520a displayed on the display portion 520 have been pressed or in a case where the portable telephone 500 has been set to the silent mode when receiving an incoming call. The portable telephone 500 is an example of the “portable device” according to the present invention.

In the portable telephone 500 including the linear motor 100 (200 to 400) according to the sixth embodiment of the present invention, the following effects can be attained:

(22) The portable telephone 500 includes the aforementioned linear motor 100 (200 to 400) as a vibration source, whereby the thickness of the portable telephone 500 can be reduced due to reduction of the thickness of the aforementioned linear motor 100 (200 to 400).

(23) The portable telephone 500 includes the aforementioned linear motor 100 (200 to 400) so that, even if a ferromagnetic body of iron or the like approaches the portable telephone 500, influence thereby exerted on the operation of the linear motor 100 (200 to 400) can be reduced since magnetic flux leakage from the linear motor 100 (200 to 400) is suppressed.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the example of employing the rectangular movable portion 120 whose corner portions are chamfered in plan view as the example of the movable portion has been shown in the first embodiment, the present invention is not restricted to this, but an unchamfered rectangular movable portion may be employed. Further, the movable portion 120 may have a shape such as a circular shape, for example, other than the rectangular shape.

While the example of constituting the movable portion 120 of the north pole face 121a, the south pole face 122a, the south pole face 121b and the north pole face 122b has been shown in each of the first to fourth embodiments, the present invention is not restricted to this. For example, the movable portion 120 may be constituted of only the north pole face 121a and the south pole face 122a, and the south pole face 121b and the north pole face 122b may not be provided. In other words, pole magnetized to magnetic properties different from each other may simply be provided along the surface opposed to the planar coils 141 and 142.

While the example of so providing the movable portion 120 as to render the first magnet 121 and the second magnet 122 adjacent to each other has been shown in each of the first to fourth embodiments, the present invention is not restricted to this, but a weight of tungsten or the like, for example, may be arranged between the first magnet 121 and the second magnet 122. In this case, the movable portion 120 can be more stably operated, due to the arrangement of the weight. At this time, further, the weight is arranged without changing the volume of the movable portion 120, whereby the weight of the movable portion 120 can be increased with the same volume as compared with a case of not arranging the weight. Thus, the quantity of vibration of the movable portion 120 can be easily increased.

While the example of providing the yoke 160a on the surfaces of the south pole face 121b and the north pole face 122b of the movable portion 120 has been shown in each of the first to fourth embodiments, the present invention is not restricted to this, but the yoke 160a may be arranged to extend from the surfaces of the south pole face 121b and the north pole face 122b up to portions of the side surfaces. In this case, magnetic flux leakage in the side surface directions (directions of arrows X1 and X2 in FIG. 3) of the movable portion 120 can be reliably suppressed.

While the example of movably supporting the movable portion 120 by the two plate springs 130 as examples of elastic members has been shown in each of the first to fourth embodiments, the present invention is not restricted to this, but elastic members such as coil springs or rubber members other than the plate springs may also be employed. Further, the movable portion 120 may be supported by at least three plate springs 130.

While the example of arranging the printed board 140 on which the planar coils 141 and 142 are arranged only on one surface side of the movable portion 120 has been shown in each of the first to fourth embodiments, the present invention is not restricted to this, but printed boards may be arranged on both surfaces of the movable portion 120 respectively. Thus, the movable portion 120 is driven from both sides thereof, whereby the driving force for the movable portion 120 can be improved. Consequently, the response time (time required by the movable portion 120 to reach a prescribed quantity of vibration) of the movable portion 120 can be reduced. In the case of arranging the printed boards 140 on both surfaces of the movable portion 120, outward magnetic flux leakage from the linear motor 100 (200 to 400) is preferably suppressed by not mounting the yoke 160a on the movable portion 120 but substitutionally providing yokes 160b on both sides of the apparatus body.

While the example of supporting the movable portion 120 to hold the same with the support portions 130c of the pair of plate springs 130 has been shown in each of the first to fourth embodiments, the present invention is not restricted to this, but the contact portions between the support portions 130c of the plate springs 130 and movable portion 120 may be bonded to each other. The same are preferably bonded as the shape of the movable portion 120 approaches a circular shape.

While the example of directly supporting the movable portion 120 by the plate springs 130 has been shown in each of the first to fourth embodiments, the present invention is not restricted to this, but the movable portion 120 may be supported by the plate springs 130 in a state arranging magnetic fluid on the surface of the movable portion 120, for example. In this case, frictional force between the movable portion 120 and the first sidewall portions 110b and frictional force between the movable portion 120 and the bottom plate 150 are reduced respectively due to the arrangement of the magnetic fluid, whereby the response time of the movable portion 120 can be reduced.

While the example of forming the planar coil 141 so that the pitch L2 of all second sections 141c (141d) of the planar coil 141 is smaller than the pitch L1 of the first sections 141a (141b) in plan view has been shown in each of the first to fourth embodiments, the present invention is not restricted to this. For example, the planar coil 141 may be formed so that the pitch L2 of parts of the second sections 141c (141d) is smaller than the pitch L1 of the first sections 141a (141b).

While the example of arranging parts of he second sections 141c (141d) of the planar coil 141 to overlap the first sidewall portions 110b of the frame body 110 respectively in plan view has been shown in each of the first to fourth embodiments, the present invention is not restricted to this, but all of the second sections 141c (141d) may be arranged to overlap the first sidewall portions 110b of the frame body 110.

While the example of forming the planar coil 141 (142) in the spiral shape having the rectangular contour has been shown in each of the first to fourth embodiments, the present invention is not restricted to this. For example, corner portions 141e of a rectangular contour of a planar coil 141 may be formed at an angle other than a right angle to be obliquely formed, as shown in FIG. 16. Particularly in the case of the second embodiment, the movable portion 220 has the shape in which both ends of a circular shape are cut off, and in the planar coil 141 whose corner portions are formed at right angles, the corner portions are not superposed on the movable portion 220, and lines of magnetic induction from these corner portions do not contribute to the driving of the movable portion 220. Therefore, the corner portions 141e are so rendered oblique as in the planar coil 141 shown in FIG. 16, that the total length of a current line 143a constituting the planar coil 141 can be reduced. Thus, the resistance value of the overall planar coil 141 can be reduced, whereby the quantity of current flowing in the planar coil 141 can be increased. Consequently, force (electromagnetic force) acting between the planar coil 141 and the movable portion 220 (permanent magnet) can be increased, whereby the driving force for the movable portion 220 can be increased, while the response time of the movable portion 220 can be reduced.

While the example of rendering the width of the second sections 141c (142c) and 141d (142d) smaller than the width of the first sections 141a (142a) and 141b (142b) of the planar coil 141 (142) has been shown in each of the first to fourth embodiments, the present invention is not restricted to this. For example, the width of first sections 141f and 141g and the width of second sections 141h and 141i may be set to the same magnitude (W5), as shown in FIG. 17. Further, the magnitudes of the widths of the first sections 141a and 141b and the second sections 141c and 141d may be identical to each other, while the line interval between the first sections 141a and 141b and the line interval between the second sections 141c and 141d may be different from each other.

While the example of rendering the width of the second sections 141c (142c) and 141d (142d) smaller than the width of the first sections 141a (142a) and 141b (142b) of the planar coil 141 (142) has been shown in each of the first to fourth embodiments, the present invention is not restricted to this. For example, the pitches of the first sections 141a and 141b and the second sections 141b and 141d may have the same magnitude, while the width of the first sections 141a and 141b may be larger than the width of the second sections 141c and 141d. Thus, the quantity of the current flowing in the first sections 141a and 141b is increased, whereby the driving force for the movable portion 120 can be further increased. Further, the width of the second sections 141c and 14d generating electromagnetic force moving the movable portion 120 in directions other than the moving path (directions of arrows X1 and X2) is so reduced that the electromagnetic force is also reduced, whereby the movable portion 120 can be inhibited from deviating from the moving path. Therefore, the linear motor 100 (200, 300, 400) can be stably operated.

While the example of employing the substance obtained by stacking the electroless nickel plating layer 22a and the fluororesin-containing nickel plating layer 22b as the nickel plating layer 22 formed on the surface of the permanent magnet 21 has been shown in the aforementioned fifth embodiment, the present invention is not restricted to this. For example, only the fluororesin-containing nickel plating layer 22b may be formed on the surface of the permanent magnet 21.

While the example of reciprocating the movable portion 20 with the pair of planar coils (a planar coil 14a and a planar coil 14b) has been shown in the aforementioned fifth embodiment, the present invention is not restricted to this. For example, the movable portion 20 may be reciprocated in a state arranging at least three planar coils.

While an example of arranging a current line 14 on the lower surface of a printed board 13 has been shown in the aforementioned fifth embodiment, the present invention is not restricted to this. For example, current lines may be stacked/arranged on both of the lower surface and the upper surface of the printed board 13. In this case, magnetic fields generated from the current lines can be reinforced, whereby the driving force for the movable portion 20 is improved, and the response time of the movable portion 20 can be reduced.

While the example of providing the example of arranging the current line 14 on the side of the printed board 13 has been shown in the aforementioned fifth embodiment, the present invention is not restricted to this. For example, another current line may be arranged also on the side of a printed board 12. In this case, the movable portion 20 is driven from the sides of both pole faces thereof, whereby the driving force for the movable portion 20 is improved, and the response time of the movable portion 20 can be reduced.

While an example of supplying the driving current (alternating current) from a control portion 15 to the current line 14 (planar coils 14a and 14b) has been shown in the aforementioned fifth embodiment, the present invention is not restricted to this. For example, the driving current may be directly supplied to the current line 14 from the exterior (the side of the portable telephone). In this case, the control portion 15 is unnecessary and the number of components is deleted, whereby the cost for the linear motor can be reduced.

In the aforementioned fifth embodiment, a low-friction layer having a smaller coefficient of friction than general epoxy resin constituting the printed board 12 may be formed on the surface of the side (upper surface side) of the printed board 12 opposed to the movable portion 20. As a material constituting such a low-friction layer, diamondlike carbon (DLC) or fullerene which is a carbon-based material, polytetrafluoroethylene (PTFE), a tetrafluoroethylene.perfluoroalkyl vinyl ether copolymer (PFA) or a tetrafluoroethylene.hexafluoropropylene copolymer (FEP) which is fluororesin, polyethylene or polypropylene which is polyolefin resin, or titanium, titanium nitride or titanium oxide which is a titanium-based material can be listed. In a case employing such a structure, frictional resistance between the movable portion 20 and a fixed portion 10 (printed board 12) is further reduced, whereby the response time of the movable portion 20 can be further reduced.

While an example of employing a circular movable portion in plan view as an example of the movable portion 20 has been shown in the aforementioned fifth embodiment, the present invention is not restricted to this. For example, a movable portion 620 having a shape in which both ends of a circular shape are cut off (shape in which two portions are cut off from a disc along two mutually parallel chords) in plan view may be employed, as shown in FIG. 18. In this case, the quantity of movement (moving range) of the movable portion 620 spreads by the cut portions as compared with a case of employing a circular movable portion, whereby the movable portion 620 is further accelerated, and the quantity of vibration of the linear motor is increased.

1. A linear motor comprising:
a spiral coil (141, 142, 441, 442); and
a movable portion (120, 220), having a pole face opposed to said spiral coil, provided to be movable along a direction along the surface of said spiral coil, wherein
said spiral coil has a first section (141a, 141b, 141f, 141g, 142a, 142b, 441a, 441b) extending along a direction intersecting with the direction along which said movable portion moves and a second section (141c, 141d, 141h, 141i, 142c, 142d, 441c, 441d) extending along direction along which said movable portion moves in plan view, and
is so formed that the magnitude of a magnetic flux of a magnetic field generated by current flowing in said first section is larger than the magnitude of a magnetic flux of a magnetic field generated by current flowing in said second section.

2. The linear motor according to claim 1, so formed that the interval between the centers of at least partial adjacent wires of said second section in the width direction is smaller than the interval between the centers of adjacent wires of said first section in the width direction.

3. The linear motor according to claim 1, so formed that the magnitude of electromagnetic force acting between the current flowing in said first section and said movable portion is larger than the magnitude of electromagnetic force acting between the current flowing in said second section and said movable portion by reducing the wire width of the wires of said second section or the interval between the wires of the wires of said second section.

4. The linear motor according to claim 1, further comprising a housing (110, 140, 150) in which said spiral coil is arranged, wherein
said second section of said spiral coil is so arranged that at least part of said second section overlaps a sidewall portion (110b) of said housing in plan view.

5. The linear motor according to claim 1, wherein
said movable portion includes a first pole face (121a, 221a) having first polarity and a second pole face (122a, 222a) having second polarity different from said first polarity in a surface opposed to said spiral coil, and is so formed as to linearly move along a direction along the surface of said coil,
the first pole face of said movable portion is formed on one direction side in the direction of movement of said movable portion while said second pole face is formed on another direction side in the direction of movement of said movable portion, and
the direction of the current flowing in said first section of said spiral coil opposed to said first pole face and e direction of the current flowing in said first section of said spiral coil opposed to said second pole face are substantially opposite directions in plan view.

6. The linear motor according to claim 1, wherein
a particulate fluororesin-containing metal plating layer (22b) is formed on at least one of surfaces of said movable portion on the side opposed to said spiral coil.

7. The linear motor according to claim 6, wherein
a bonding metal plating layer (22a) serving as a bonding layer is provided between said movable portion and said particulate fluororesin-containing metal plating layer.

8. The linear motor according to claim 6, wherein
said movable portion includes a permanent magnet (21), and
said particulate fluororesin-containing metal plating layer is formed on a portion of said permanent magnet on a side coming into contact with at least said fixed portion.

9. The linear motor according to claim 1, wherein
said spiral coil includes a spiral planar coil.

10. The linear motor according claim 1, wherein
said spiral coil is substantially rectangularly formed in plan view.

11. The linear motor according to claim 1, further comprising a housing in which said spiral coil is arranged, wherein
the first section of said spiral coil is provided on each of one direction side and another direction side of said housing in the direction along which said movable portion moves.

12. The linear motor according to claim 1, further comprising a housing in which said spiral coil is arranged, wherein
said spiral coil is arranged on at least one direction side of said housing in the thickness direction of said movable portion.

13. The linear motor according to claim 1, further comprising a movable portion-side yoke (160a) provided on a surface of said movable portion opposite a surface opposed to said spiral coil.

14. The linear motor according to claim 1, further comprising a coil-side yoke (160b) provided on a side of said spiral coil opposite to said movable portion.

15. The linear motor according to claim 1, wherein
said spiral coil is formed in a two-layer structure of an upper-layer said spiral coil (141, 441) spirally wound from the outer side toward the inner side and a lower-layer said spiral coil (142, 442) spirally wound from the inner side toward the outer side in plan view, and
said upper-layer spiral coil and said lower-layer spiral coil are so connected with each other that the current lows in the same direction in a portion of said upper-layer spiral coil and a portion of said lower-layer spiral coil corresponding to the portion of said upper-layer spiral coil.

16. The linear motor according to claim 1, wherein
said movable portion has a rectangular shape whose corner portion is chamfered in plan view.

17. A portable device provided with a linear motor (100, 200, 300, 400) comprising a spiral coil (141, 142, 441, 442) and a movable portion (120, 220), having a pole face opposed to said spiral coil, provided to be movable along a direction along the surface of said spiral coil, wherein said spiral coil has a first section (141a, 141b, 141f, 141g, 142a, 142b, 441a, 441b) extending along a direction intersecting with the direction along which said movable portion moves and a second section (141c, 141d, 141h, 141i, 142c, 142d, 441c, 441d) extending along the direction along which said movable portion moves in plan view, and is so formed that the magnitude of a magnetic flux of a magnetic field generated by current flowing in said first section is larger than the magnitude of a magnetic flux of a magnetic field generated by current flowing in said second section.
